(19) United States
(12) Patent Application Publication
(10) Pub. No.: US 2025/0118845 A1
(43) Pub. Date: Apr. 10, 2025

(54) POWER STORAGE DEVICE

(71) Applicant: TOYOTA JIDOSHA KABUSHIKI KAISHA, Toyota-shi (JP)

(72) Inventors: Tatsuma YAHARA, Seto-shi (JP); Shigeyuki Inoue, Toyota-shi (JP)

(73) Assignee: TOYOTA JIDOSHA KABUSHIKI KAISHA, Toyota-shi (JP)

(21) Appl. No.: 18/765,741

(22) Filed: Jul. 8, 2024

(30) Foreign Application Priority Data
Oct. 4, 2023 (JP) 2023-172823

(51) Int. Cl. H01M 50/242; B60R 16/033; H01M 10/42; H01M 50/209; H01M 50/262; H01M 50/289

(52) U.S. Cl. CPC H01M 50/242; H01M 10/425; H01M 50/209; H01M 50/262; H01M 50/289; B60R 16/033; H01M 2220/20

(57) ABSTRACT

The power storage device includes a first power storage module and a second power storage module, a case that houses the first power storage module and the second module, a cross member, a mount member fixed to an upper surface of the cross member, and an electronic device. The height of the mount member in the vertical direction is higher than the height of the electronic device, the electronic device is disposed so as to be adjacent to the mount member in the second direction, and includes a first end portion located on the mount member side in the second direction and a second end portion located on the opposite side to the side where the mount member is located in the second direction, the first end portion is fixed to the mount member, the second end portion is fixed to the cross member.

### CROSS-REFERENCE TO RELATED APPLICATION

This application claims priority to Japanese Patent Application No. 2023-172823 filed on Oct. 4, 2023, incorporated herein by reference in its entirety.

### BACKGROUND

### 1. Technical Field

The present disclosure relates to a power storage device.

### 2. Description of Related Art

As a conventional power storage device, Japanese Patent No. 6003838 discloses a battery module including a plurality of unit cells arranged side by side and a restraint that integrates the unit cells. The battery module has a configuration in which at least one of a battery monitoring electronic control unit (ECU) that monitors the state of the unit cells and a switching element unit that includes switching elements controlled by the battery monitoring ECU is thermally bonded to the restraint.

### SUMMARY

In the configuration disclosed in Japanese Patent No. 6003838, however, a stress acts on the restraint when the single cells generate heat and the battery module thermally expands. In this case, a stress is applied to a substrate of the battery monitoring ECU or a substrate of the switching elements joined to the restraint. Similarly, a stress is applied to the substrate of the battery monitoring ECU or the substrate of the switching elements joined to the restraint also when the battery module shrinks. Therefore, the battery monitoring ECU or the switching element may not operate normally.

The present disclosure has been made in view of the above-described problem, and an object of the present disclosure is to provide a power storage device capable of reducing a stress applied to an electronic device that monitors a power storage module.

An aspect of the present disclosure provides a power storage device including:
a first power storage module and a second power storage module disposed side by side in a first direction orthogonal to an up-down direction;
a case that houses the first power storage module and the second power storage module;
a cross member disposed between the first power storage module and the second power storage module in the case, and extending in the up-down direction and a second direction orthogonal to the first direction;
a mount member fixed to an upper surface of the cross member; and
an electronic device that monitors the first power storage module or the second power storage module.
   A height of the mount member in the up-down direction is greater than a height of the electronic device.
   The electronic device is disposed adjacent to the mount member in the second direction, and includes a first end portion positioned on a side of the mount member in the second direction and a second end portion positioned on a side opposite to the side where the mount member is positioned in the second direction.
   The first end portion is fixed to the mount member.
   The second end portion is fixed to the cross member.

According to the above configuration, the electronic device is disposed on the cross member disposed between the first power storage module and the second power storage module. Therefore, it is possible to suppress a stress caused by expansion or contraction of the first power storage module and the second power storage module being transmitted to the electronic device.

In addition, when a stress is input from the upper side of the case, the stress can be transmitted to the bottom wall portion of the case via the mount member having a height greater than that of the electronic device and the cross member. When a stress is input from the lower side of the case, on the other hand, the stress can be transmitted to the upper wall portion of the case via the cross member and the mount member. Therefore, even when a stress is input to the case in the up-down direction, it is possible to suppress the stress being transmitted to the electronic device.

Further, it is possible to suppress the acceleration input to the electronic device with respect to the vibration input during travel of the vehicle, since the first end portion of the electronic device is fixed to the mount member and the second end portion of the electronic device is fixed to the cross member.

In the power storage device according to the aspect of the present disclosure, the mount member may include a column portion positioned on a side of the first end portion of the electronic device in the second direction, a height of the column portion in the up-down direction being greater than that of the electronic device, and an outer end portion provided adjacent to the column portion so as to be positioned closer to the side of the first end portion than the column portion in the second direction, the first end portion being fixed to the outer end portion.

A height of the outer end portion may be less than the height of the column portion in the up-down direction.
A fragile portion may be provided at a boundary portion between the outer end portion and the column portion.

According to the above configuration, it is possible to suppress a stress acting on the column portion being transmitted to the outer end portion when a stress is input to the case in the up-down direction, since the fragile portion is broken.

In the power storage device according to the aspect of the present disclosure, the mount member may include a first lower surface portion that constitutes a lower surface of the column portion and a second lower surface portion that constitutes a lower surface of the outer end portion.

The first lower surface portion may be provided with an insertion portion to be inserted into the cross member.
The outer end portion may be provided with a fixed portion fixed to a fastening member provided on the cross member on the side of the first end portion and on a lower side.
The first lower surface portion may be in contact with the upper surface of the cross member. The second lower surface portion may be provided so as to be spaced upward from the upper surface of the cross member.

According to the above configuration, the fragile portion can be easily broken, since the second lower surface portion is disposed between the fastened portion and the insertion portion so as to be separated from the upper surface of the cross member. Accordingly, it is possible to suppress a stress acting on the column portion being transmitted to the outer end portion when a stress is input to the case in the up-down direction.

According to the present disclosure, it is possible to provide a power storage device capable of reducing a stress applied to an electronic device that monitors a power storage module.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an exploded perspective view of a power storage device according to an embodiment;

FIG. 2 is a perspective view schematically illustrating a configuration of the power storage device according to the embodiment;

FIG. 3 is a schematic perspective view illustrating a fixing structure of an electronic device in the power storage device according to the embodiment;

FIG. 4 is a cross-sectional view taken along IV-IV line shown in FIG. 3; and

FIG. 5 is a diagram illustrating a state in which the mount member according to the embodiment is broken.

### DETAILED DESCRIPTION OF EMBODIMENTS

Hereinafter, embodiments of the present disclosure will be described in detail with reference to the drawings. In the following embodiments, the same or common parts are denoted by the same reference numerals in the drawings, and the description thereof will not be repeated.

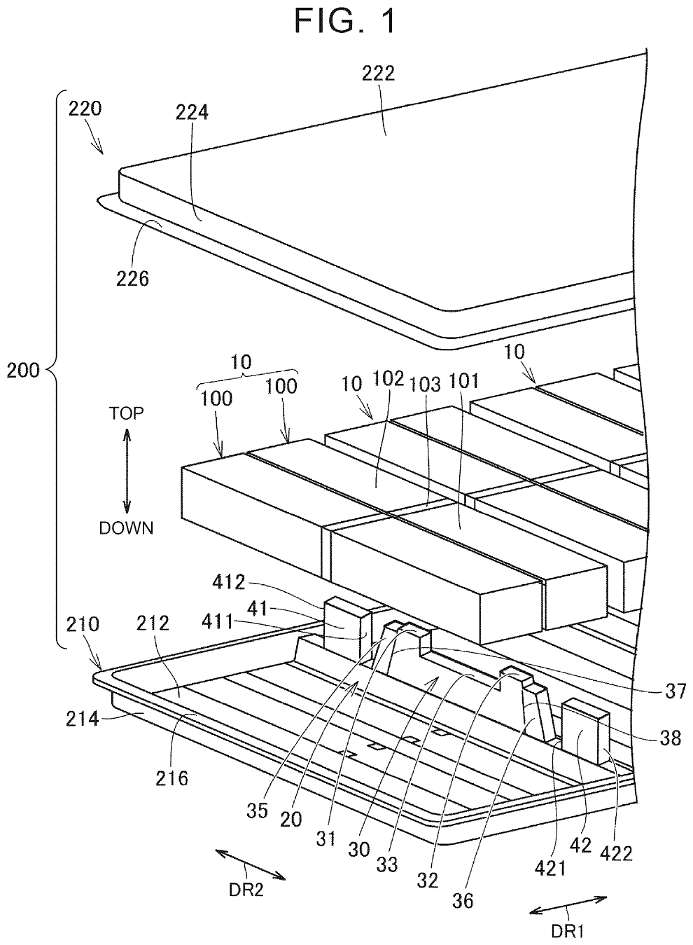

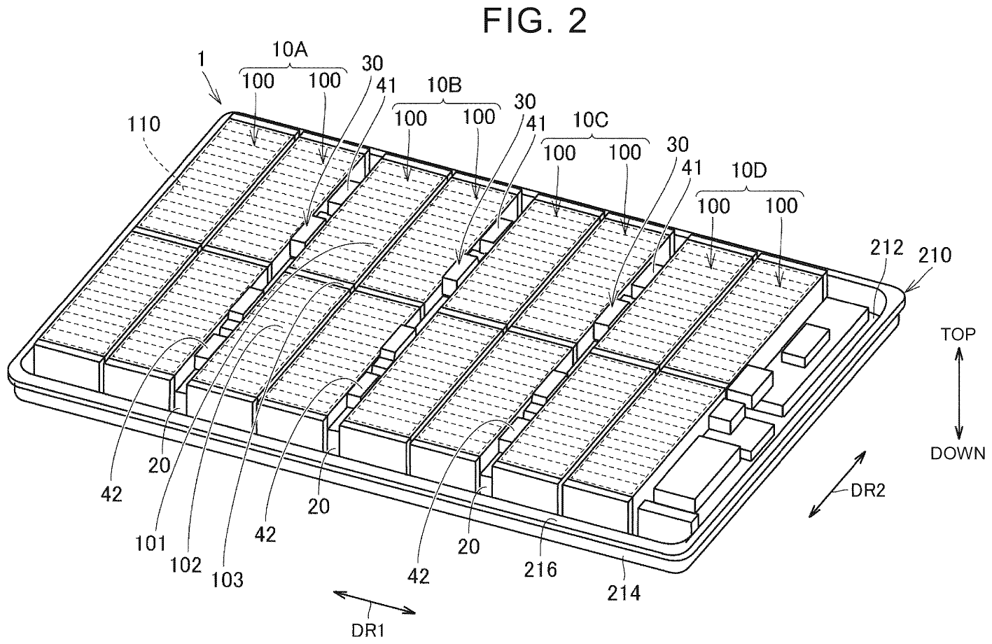

FIG. 1 is an exploded perspective view of a power storage device according to an embodiment. FIG. 2 is a perspective view schematically showing a configuration of the power storage device according to the embodiment. The power storage device 1 according to the embodiment will be described with reference to FIGS. 1 and 2.

As illustrated in FIGS. 1 and 2, the power storage device 1 includes a plurality of power storage modules 10, a plurality of cross members 20, a plurality of mount members 30, a plurality of electronic devices 41 and 42, and a case 200.

The plurality of power storage modules 10 are arranged side by side at intervals in a first direction (DR1 direction) perpendicular to the vertical direction. The plurality of power storage modules 10 includes, for example, four power storage modules 10, and includes a first power storage module 10A, a second power storage module 10B, a third power storage module 10C, and a fourth power storage module 10D. The first power storage module 10A, the second power storage module 10B, the third power storage module 10C, and the fourth power storage module 10D are arranged in this order in the first direction.

The number of the power storage modules 10 is not limited to four, and may be two or more. Further, in the mounted state in which the power storage device 1 is mounted on the vehicle, the first direction is, for example, parallel to the front-rear direction of the vehicle.

Each power storage module 10 may include a plurality of power storage stacks 100. In the present embodiment, each power storage module 10 includes two power storage stacks 100. The number of the power storage stacks 100 included in the power storage module 10 is not limited to two, and may be one or three or more. The plurality of power storage stacks 100 are arranged side by side in the first direction.

Each power storage stack 100 includes a first unit stack 101, a second unit stack 102, and an intermediate plate 103.

Each of the first unit stack 101 and the second unit stack 102 includes a plurality of power storage cells 110 arranged in a second direction (DR2 direction) perpendicular to the up-down direction and the first direction. The power storage cell 110 is, for example, a secondary battery such as a nickel metal hydride battery or a lithium-ion battery. The power storage cell 110 has, for example, a square shape. The power storage cell 110 may use a liquid electrolyte or a solid electrolyte.

The first unit stack 101 is disposed on one side in the second direction. The first unit stack 101 may include an end plate. The end plate is disposed on the outside of the power storage cell 110 disposed on the outermost side on one side in the second direction.

The second unit stack 102 is disposed on the other side in the second direction. In the present embodiment, the number of the power storage cells 110 included in the second unit stack 102 is the same as the number of the power storage cells 110 included in the first unit stack 101, but may be different. The second unit stack 102 may include an end plate disposed outside the power storage cell 110 on the other side in the second direction.

The intermediate plate 103 is disposed between the first unit stack 101 and the second unit stack 102. The intermediate plate 103 is disposed at the center of the power storage stack 100 in the second direction. The intermediate plate 103 is made of a synthetic resin or the like.

The case 200 houses the plurality of power storage modules 10, the plurality of cross members 20, the plurality of mount members 30, and the plurality of electronic devices 41 and 42. The case 200 includes a lower case 210 and an upper case 220. In FIG. 2, the upper case 220 is omitted for convenience.

The lower case 210 has a substantially box shape that opens upward. The lower case 210 is made of metal, synthetic resin, or the like. The lower case 210 includes a bottom wall 212, a lower side peripheral wall portion 214, and a lower side flange 216.

The bottom wall 212 is disposed below the plurality of power storage modules 10. A cooler (not shown) for cooling the power storage stack 100 via the bottom wall 212 may be provided below the bottom wall 212. In this case, a heat conduction member may be provided between the cooler and the bottom wall 212, and a heat conduction member may be provided between each of the power storage stacks 100 and the bottom wall 212. As the heat conductive member, for example, an adhesive containing a silicone-based resin, an acrylic-based resin, an epoxy resin, or the like, a grease, or the like can be employed.

The lower side peripheral wall portion 214 stands up from the peripheral edge portion of the bottom wall 212 and surrounds the periphery of the lower portions of the plurality of power storage modules 10. The lower side flange 216 has a shape protruding outward from an upper end portion of the lower side peripheral wall portion 214.

The upper case 220 has a substantially box shape that opens downward. The upper case 220 houses the plurality of power storage modules 10 together with the lower case 210. The upper case 220 is made of metal, synthetic resin, or the like. The upper case 220 includes a top wall 222, an upper side peripheral wall portion 224, and an upper side flange 226.

The top wall 222 is disposed above the plurality of power storage stacks 100. The top wall 222 faces the bottom wall 212 in the up-down direction. The top wall 222 may be formed in a flat plate shape. A gap is formed between the top wall 222 and each of the power storage modules 10.

The upper side peripheral wall portion 224 extends downward from the peripheral edge portion of the top wall 222 and surrounds the periphery of the upper portions of the plurality of power storage modules 10. The upper side peripheral wall portion 224 constitutes a peripheral wall of the case 200 together with the lower side peripheral wall portion 214. The lower side peripheral wall portion 214 and the upper side peripheral wall portion 224 connect the peripheral edge portion of the bottom wall 212 and the peripheral edge portion of the top wall 222, and surround the periphery of the plurality of power storage stacks 100.

The upper side flange 226 has a shape protruding outward from a lower end portion of the upper side peripheral wall portion 224. The upper side flange 226 is fixed to the lower side flange 216 by bolts or the like.

Each of the plurality of cross members 20 is disposed in each gap between the power storage modules 10 adjacent to each other in the first direction. Specifically, the cross member 20 is disposed in a gap between the first power storage module 10A and the second power storage module 10B. The cross member 20 is disposed in a gap between the second power storage module 10B and the third power storage module 10C. The cross member 20 is disposed in a gap between the third power storage module 10C and the fourth power storage module 10D.

The cross member 20 is fixed to the bottom wall 212. The bottom wall 212 extends along the second direction. Both ends of the cross member 20 may be connected to the lower side peripheral wall portion 214. The cross section of the cross member 20 orthogonal to the second direction is formed in a shape convex upward. Specifically, the cross member 20 includes, for example, an upper wall portion constituting the upper surface 20a and a pair of upright wall portions extending downward from both sides of the upper wall portion in the first direction. A space may be provided between the upper wall portion and the bottom wall 212. The upper surface 20a is formed to be substantially flat.

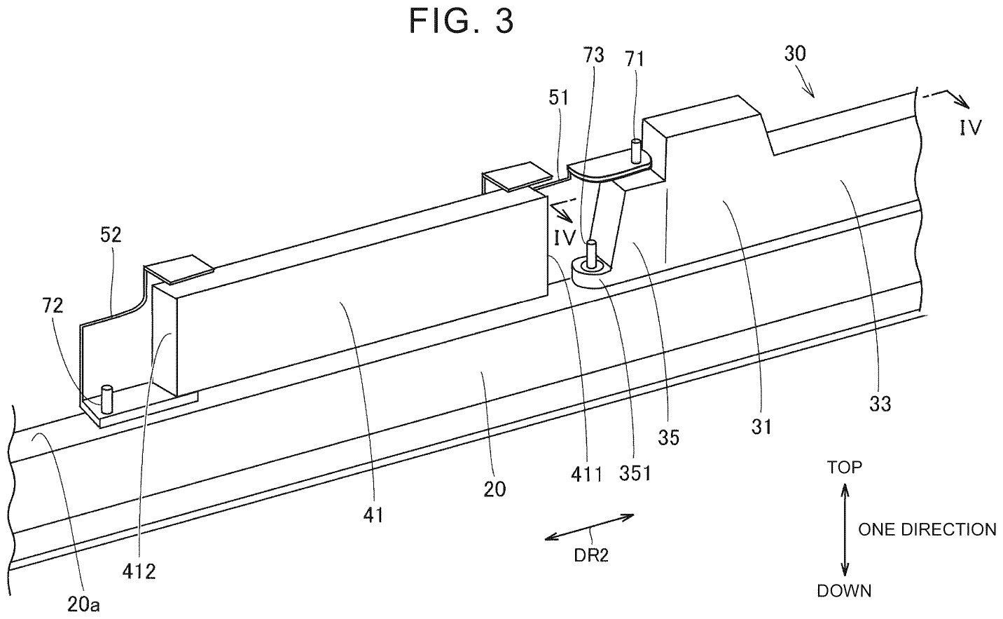

The mount member 30 is fixed to the upper surface 20a (see FIG. 3) of the cross member 20. The mount member 30 includes a first column portion 31, a second column portion 32, a connecting portion 33, a first outer end portion 35, and a second outer end portion 36.

The first column portion 31 and the second column portion 32 are located on the cross member 20 at a distance from each other in the second direction. The first column portion 31 is located on one side of the second column portion 32 in the second direction. The upper end portion of the first column portion 31 and the upper end portion of the second column portion 32 may be in contact with the top wall 222 or may be spaced apart from the top wall 222.

The heights of the first column portion 31 and the second column portion 32 in the up-down direction are larger than the heights of the connecting portion 33, the first outer end portion 35, and the second outer end portion 36. In addition, the heights of the first column portion 31 and the second column portion 32 in the up-down direction are larger than the heights of the electronic devices 41 and 42. Accordingly, the first column portion 31 and the second column portion 32 transmit the load input downward to the top wall 222 to the cross member 20. Similarly, the first column portion 31 and the second column portion 32 transmit the load input upward with respect to the bottom wall 212 from the cross member 20 to the top wall 222.

The connecting portion 33 connects the first column portion 31 and the second column portion 32. The connecting portion 33 extends along the second direction.

The first outer end portion 35 constitutes an end portion of the mount member 30 on one side in the second direction. The first outer end portion 35 is provided so as to be located closer to the first end portion 411 side of the electronic device 41 than the first column portion 31 in the second direction. As will be described later, the first end portion 411 of the electronic device 41 is fixed to the first outer end portion 35.

The first outer end portion 35 is provided adjacent to the first column portion 31. A first fragile portion 37 is provided at a boundary portion between the first outer end portion 35 and the first column portion 31.

The second outer end portion 36 constitutes an end portion of the mount member 30 on the other side in the second direction. The second outer end portion 36 is provided so as to be located closer to the first end portion 421 side of the electronic device 42 than the second column portion 32 in the second direction. As described later, the first end portion 421 of the electronic device 42 is fixed to the second outer end portion 36.

The second outer end portion 36 is provided adjacent to the second column portion 32. A second fragile portion 38 is provided at a boundary portion between the second outer end portion 36 and the second column portion 32.

The electronic device 41 is located on one side of the mount member 30 in the second direction. The electronic device 41 is disposed adjacent to the mount member 30 in the second direction. The electronic device 41 is disposed on the mount member 30.

The electronic device 41 has a first end portion 411 and a second end portion 412 in a second direction. The first end portion 411 is located on the mount member 30 side in the second direction. The second end portion 412 is located on the side opposite to the side where the mount member 30 is located in the second direction.

The electronic device 41 is a monitoring unit that monitors the power storage module 10. The electronic device 41 monitors at least one of the power storage modules 10 adjacent to each other. Specifically, for example, the electronic device 41 located between the first power storage module 10A and the second power storage module 10B monitors at least one of them.

The electronic device 42 is located on one side of the mount member 30 in the second direction. The electronic device 42 is disposed adjacent to the mount member 30 in the second direction. The electronic device 42 is disposed on the mount member 30.

The electronic device 42 has a first end portion 421 and a second end portion 422 in a second direction. The first end portion 421 is located on the mount member 30 side in the second direction. The second end portion 422 is located on the side opposite to the side where the mount member 30 is located in the second direction.

The electronic device 42 is a monitoring unit that monitors the power storage module 10 different from the electronic device 41. For example, when the electronic device 41 monitors the first power storage module 10A, the electronic device 42 located between the first power storage module 10A and the second power storage module 10B monitors the second power storage module 10B.

FIG. 3 is a schematic perspective view illustrating a fixing structure of an electronic device in the power storage device according to the embodiment. A fixing structure of the electronic device 41 will be described with reference to FIG. 3.

As shown in FIG. 3, the first end portion 411 of the electronic device 41 is fixed to the mount member 30, and the second end portion 412 of the electronic device 41 is fixed to the cross member 20.

Specifically, the first end portion 411 of the electronic device 41 is fixed to the first outer end portion 35 by the inner connecting member 51. The inner connecting member 51 has a shape extending from the first end portion 411 toward the mount member 30. An end portion of the inner connecting member 51 located on the side of the mount member 30 is fixed to a bolt 71 protruding from the upper surface of the first outer end portion 35. An end portion of the inner connecting member 51 located on the electronic device 41 side is fixed to the first end portion 411 side.

The second end portion 412 of the electronic device 41 is fixed to the upper surface 20a of the cross member 20 on one side of the second end portion 412 in the second direction by the outer connecting member 52. The outer connecting member 52 has a shape extending from the second end portion 412 toward one side in the second direction. An end portion of the outer connecting member 52 located on the electronic device 41 side is fixed to the second end portion 412 side. An end portion of the outer connecting member 52 located on one side in the second direction is fixed to a bolt 72 protruding upward from the upper surface 20a of the cross member 20.

The electronic device 42 is also fixed in the same manner as the electronic device 41. Specifically, the first end portion 421 of the electronic device 42 is fixed to the second outer end portion 36 of the mount member 30 by an inner connecting member (not shown). The second end portion 422 of the electronic device 42 is fixed to the upper surface 20a of the cross member 20 on the other side of the second end portion 422 in the second direction by an outer connecting member (not shown).

As described above, the electronic devices 41 and 42 are installed on the cross member 20 disposed between the power storage modules 10 adjacent to each other. Therefore, when the power storage module 10 expands or contracts, it is possible to prevent the stress caused by the expansion or contraction from being transmitted to the electronic devices 41 and 42.

The height of the electronic devices 41 and 42 is lower than the height of the mount member 30. Therefore, when the stress is input to the case 200 in the vertical direction, the stress can be transmitted from the top wall 222 to the bottom wall 212 or from the bottom wall 212 to the top wall 222 via the cross member 20 and the mount member 30. Thus, it is possible to prevent the stress from being transmitted to the electronic devices 41 and 42.

Further, as described above, in each of the electronic devices 41 and 42, one end portion of both ends of the electronic devices 41 and 42 is fixed to the mount member 30, and the other end portion is fixed to the cross member 20. Accordingly, it is possible to suppress the input acceleration to the electronic devices 41 and 42 with respect to the vibration input during the traveling of the vehicle.

In addition, even in a situation where it is difficult to fix the end portions (first end portions) of the electronic devices 41 and 42 located on the side of the mount member 30 to the cross member 20, the electronic devices 41 and 42 can be stably fixed by fixing the first end portions to the mount member 30.

The first outer end portion 35 is provided with a fixed portion 351 on the first end portion 411 side (one side in the first direction) and the lower side. The fixed portion 351 is fixed to a bolt 73 as a fastening member provided on the cross member 20.

Similarly, the second outer end portion 36 is provided with a fixed portion on the first end portion 421 side (the other side in the first direction) and the lower side. The flying boat is fixed to a bolt as a fastening member provided on the cross member 20.

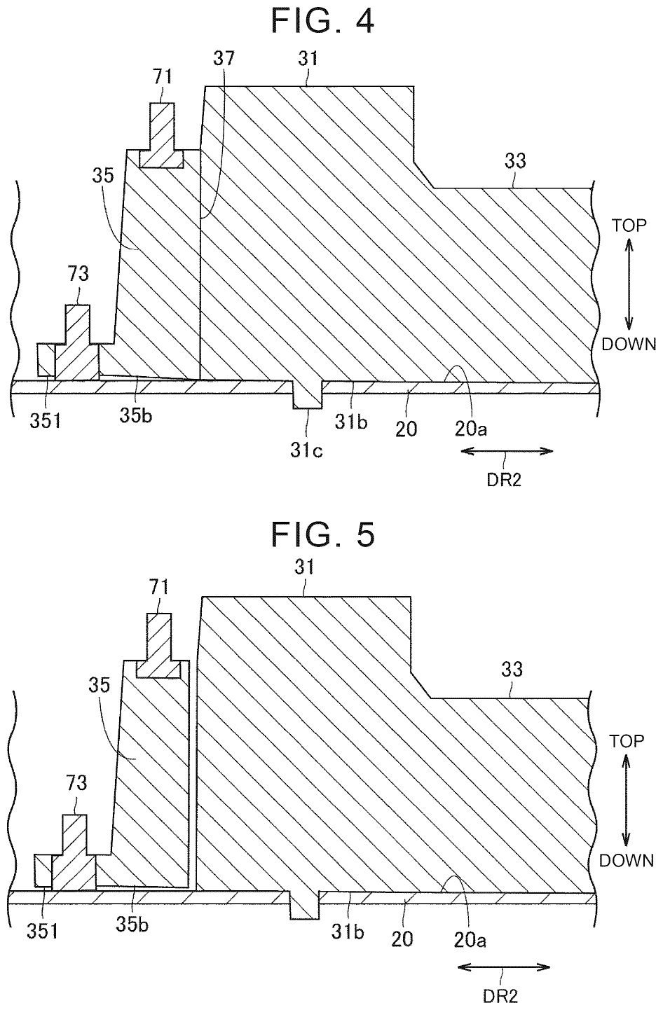

FIG. 4 is a cross-sectional view taken along IV-IV shown in FIG. 3. As shown in FIG. 4, the mount member 30 has a first lower surface portion 31b that constitutes the lower surface of the first column portion 31 and a second lower surface portion 35b that constitutes the lower surface of the first outer end portion 35. The first lower surface portion 31b is provided with an insertion portion 31c protruding downward. The insertion portion 31c is inserted into the upper surface 20a of the cross member 20. Also on the second column portion 32 side, an insertion portion is provided on the lower surface of the second column portion 32, and the insertion portion is inserted into the upper surface 20a. The first lower surface portion 31b is in contact with the upper surface 20a.

The second lower surface portion 35b is provided so as to be spaced upward from the upper surface 20a of the cross member 20. Specifically, the second lower surface portion 35b is inclined upward as it moves away from the first column portion 31 in the second direction. The lower surface 351a of the fixed portion 351 is substantially parallel to the upper surface 20a. Similarly, also on the second outer end portion 36 side, the lower surface portion (third lower surface portion) of the second outer end portion 36 is inclined upward as it moves away from the second column portion 32.

The second lower surface portion 35b and the third lower surface portion may be provided so as to form a stepped portion with respect to the first lower surface portion 31b. In this case, the second lower surface portion 35b and the third lower surface portion may be provided substantially parallel to the upper surface 20a.

FIG. 5 is a diagram illustrating a state in which the mount member according to the embodiment is broken. As described above, the first fragile portion 37 is provided at a boundary portion between the first column portion 31 and the first outer end portion 35. The first fragile portion 37 is constituted by a notch such as a notch or a notch, for example.

As illustrated in FIG. 5, the first fragile portion 37 is provided so as to be breakable when a predetermined load is applied to the mount member 30. When a large stress is applied to the case 200 due to a collision of a vehicle or the like and a stress is received by the mount member 30, the first fragile portion 37 is broken, thereby preventing the stress from being transmitted from the mount member 30 side to the electronic device 41. Similarly, when the second fragile portion 38 is broken, it is possible to prevent the stress from being transmitted from the mount member 30 side to the electronic device 42. As a result, damage to the electronic devices 41 and 42 can be suppressed.

Further, as described above, since the second lower surface portion 35b and the third lower surface portion are provided so as to be spaced upward from the upper surface 20a, the first fragile portion 37 and the second fragile portion 38 can be easily broken when stresses are inputted to the mount member 30.

### Other Variations

In the above description, the case where the first end portions of the electronic devices 41 and 42 are indirectly fixed to the mount member 30 via the inner connecting member has been described as an example, but the inner connecting member may be omitted, and the first end portions may be directly fixed to the mount member 30.

In the above description, the case where the second end portions of the electronic devices 41 and 42 are fixed to the cross member 20 via the outer connecting member has been described as an example, but the outer connecting member may be omitted, and the second end portions may be directly fixed to the cross member 20.

The embodiments disclosed herein are illustrative and not restrictive in all respects. The scope of the present disclosure is defined by the claims, and includes all modifications within the meaning and range equivalent to the claims.

What is claimed is:

1. A power storage device comprising:
a first power storage module and a second power storage module disposed side by side in a first direction orthogonal to an up-down direction;
a case that houses the first power storage module and the second power storage module;
a cross member disposed between the first power storage module and the second power storage module in the case, and extending in the up-down direction and a second direction orthogonal to the first direction;
a mount member fixed to an upper surface of the cross member; and
an electronic device that monitors the first power storage module or the second power storage module, wherein:
a height of the mount member in the up-down direction is greater than a height of the electronic device; and
the electronic device is disposed adjacent to the mount member in the second direction, and includes a first end portion positioned on a side of the mount member in the second direction and a second end portion positioned on a side opposite to the side where the mount member is positioned in the second direction;
the first end portion is fixed to the mount member; and
the second end portion is fixed to the cross member.

2. The power storage device according to claim 1, wherein:
the mount member includes a column portion positioned on a side of the first end portion of the electronic device in the second direction, a height of the column portion in the up-down direction being greater than that of the electronic device, and an outer end portion provided adjacent to the column portion so as to be positioned closer to the side of the first end portion than the column portion in the second direction, the first end portion being fixed to the outer end portion;
a height of the outer end portion is less than the height of the column portion in the up-down direction; and
a fragile portion is provided at a boundary portion between the outer end portion and the column portion.

3. The power storage device according to claim 2, wherein:
the mount member includes a first lower surface portion that constitutes a lower surface of the column portion and a second lower surface portion that constitutes a lower surface of the outer end portion;
the first lower surface portion is provided with an insertion portion to be inserted into the cross member;
the outer end portion is provided with a fixed portion fixed to a fastening member provided on the cross member on the side of the first end portion and on a lower side;
the first lower surface portion is in contact with the upper surface of the cross member; and
the second lower surface portion is provided so as to be spaced upward from the upper surface of the cross member.
